(19) United States
(12) Patent Application Publication
(10) Pub. No.: US 2022/0254217 A1
(43) Pub. Date: Aug. 11, 2022

(54) DYNAMIC LABEL CONTROL FOR SHELVED ITEMS

(71) Applicant: ZEBRA TECHNOLOGIES CORPORATION, Lincolnshire, IL (US)

(72) Inventor: Yuri Astvatsaturov, Lake Forest, IL (US)

(21) Appl. No.: 17/168,517

(22) Filed: Feb. 5, 2021

(51) Int. Cl. G07F 9/02; G07F 9/00; G07F 11/16; G07F 11/00; G06K 7/10

(52) U.S. Cl. CPC G07F 9/023; G07F 9/002; G06K 7/10099; G07F 11/004; G07F 11/16

(57) ABSTRACT

A method for accurate cost reporting of shelved items includes: storing a plurality of data sets corresponding to respective chutes in a facility, each data set containing (i) an item identifier, (ii) label data, and (iii) an identifier of a dynamic label disposed at a corresponding chute; receiving, from a sensor mounted at or near a first one of the chutes, a detected item identifier corresponding to a forward position in the chute that is adjacent to an edge of a shelf defining the chute; retrieving, from the repository, (i) the identifier of a first dynamic label corresponding to the first chute, and (ii) detected label data from one of the data sets containing the detected item identifier; and sending a command to the first dynamic label, the command containing the detected label data, for causing the first dynamic label to display the detected label data.

### BACKGROUND

Items in retail facilities may be arranged on shelves, with labels affixed to the shelves for each item, indicating information such as the price of the item. The placement of an item in an incorrect location may result in a mismatch between the item itself and the information on the label corresponding to that location.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a diagram of a system for dynamic label control for shelved items.

FIG. 2 is a flowchart of a method of controlling the dynamic labels.

FIG. 3 is a diagram illustrating a front view of the shelf shown in FIG. 1.

FIG. 4 is a diagram of the shelf of FIG. 3, illustrating an example performance of block 205 of the method of FIG. 2.

FIG. 5 is a diagram of the shelf of FIG. 3, illustrating an example performance of block 235 of the method of FIG. 2.

FIG. 6 is a flowchart illustrating alert functionality in the method of FIG. 2.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

Examples disclosed herein are directed to a method for accurate cost reporting of shelved items, comprising: storing a plurality of data sets corresponding to respective chutes in a facility, each data set containing (i) an item identifier, (ii) label data, and (iii) an identifier of a dynamic label disposed at a corresponding chute; receiving, from a sensor mounted at or near a first one of the chutes, a detected item identifier corresponding to a forward position in the chute that is adjacent to an edge of a shelf defining the chute; retrieving, from the repository, (i) the identifier of a first dynamic label corresponding to the first chute, and (ii) detected label data from one of the data sets containing the detected item identifier; and sending a command to the first dynamic label, the command containing the detected label data, for causing the first dynamic label to display the detected label data.

Additional examples disclosed herein are directed to a computing device, comprising: a memory storing a plurality of data sets corresponding to respective chutes in a facility, each data set containing (i) an item identifier, (ii) label data, and (iii) an identifier of a dynamic label disposed at a corresponding chute; a communications interface; and a processor configured to: receive, from a sensor mounted at a first one of the chutes, a detected item identifier corresponding to a forward position in the chute that is adjacent to an edge of a shelf defining the chute; retrieve, from the repository, (i) the identifier of a first dynamic label corresponding to the first chute, and (ii) detected label data from one of the data sets containing the detected item identifier; and send a command to the first dynamic label, the command containing the detected label data, for causing the first dynamic label to display the detected label data.

Further examples disclosed herein include a system, comprising: a plurality of sensors disposed at respective chutes in a facility; a plurality of dynamic labels disposed at respective ones of the chutes; and a computing device including: a memory storing a plurality of data sets corresponding to respective ones of the chutes in a facility, each data set containing (i) an item identifier, (ii) label data, and (iii) an identifier of the dynamic label disposed at a corresponding chute; a communications interface; and a processor configured to: receive, from one of the sensors at a first one of the chutes, a detected item identifier corresponding to a forward position in the chute that is adjacent to an edge of a shelf defining the chute; retrieve, from the repository, (i) the identifier of a first one of the dynamic labels corresponding to the first chute, and (ii) detected label data from one of the data sets containing the detected item identifier; and send a command to the first dynamic label, the command containing the detected label data, for causing the first dynamic label to display the detected label data.

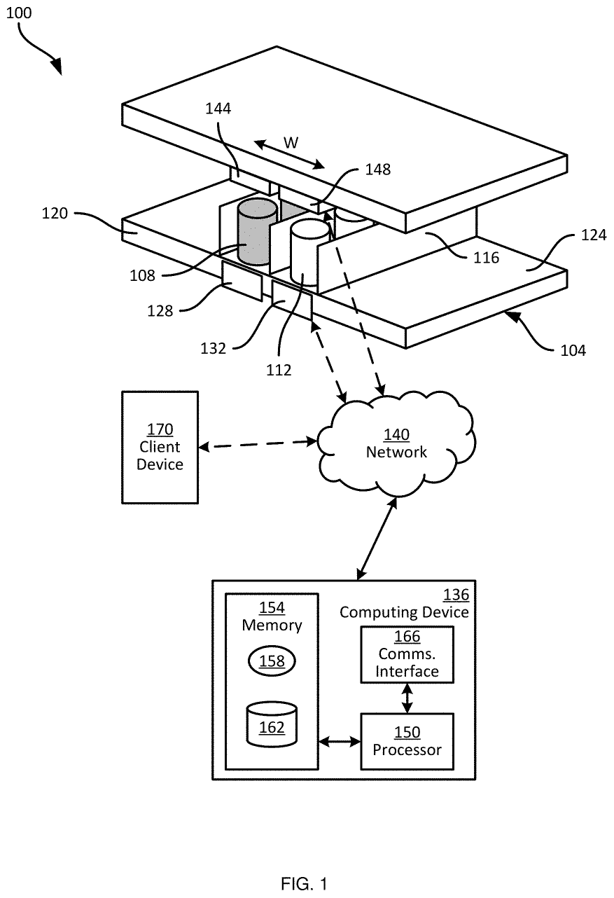

FIG. 1 illustrates a system 100 for dynamic label control for shelved items, such as products for purchase in a retail facility. The facility includes support surfaces such as a shelf 104, upon which items 108 and 112 can be supported. Each item 108, 112 is assigned a given location on the shelf 104, e.g., as indicated in a planogram of the retail facility. In the illustrated example, the locations assigned to the items 108 and 112 are defined physically by respective chutes, e.g., formed by dividers 116.

Preferably, each of the chutes formed by the dividers 116 has a width measured in the direction “W” that is smaller than twice the width of the respective items 108 and 112. That is, the chute containing the items 108 is only wide enough to accommodate a single column of the items 108, and the chute containing the items 112 is only wide enough to accommodate a single column of the items 112. As a result, the most forward position in each chute (i.e., the position closest to an edge 120 of the shelf) is occupied by a single item 108 or 112. As will now be apparent, as items 108 or 112 are withdrawn from the chutes (e.g., by customers in the retail facility), subsequent items 108 or 112 in the columns may slide forward to the forward position, e.g., under the action of spring-loaded platforms at the back of each chute, or as a result of a lower surface 124 of the shelf 104 being sloped downwards towards the shelf edge 120.

As will be apparent to those skilled in the art, locations assigned to items in the facility generally also bear labels including information such as a price of the corresponding item, a name of the corresponding item, and the like. In facilities in which such labels are static (e.g., paper labels affixed to the shelf edge 120), misplaced items result in a mismatch between the item in the forward position of a chute and the information presented on the corresponding label. Further, particularly in facilities that make use of chutes such as those shown in FIG. 1, visibility of the items behind the foremost item may be limited, and therefore there may be little or no indication to a customer that the label information presented in connection with the chute does not match the forward item in the chute. Such a mismatch can lead to a customer discovering at checkout that an item costs more than expected, for example.

The system 100 implements various features to mitigate against the effects of misplaced items. In particular, the system 100 includes dynamic labels 128 and 132 associated with each chute, rather than the above-mentioned static labels. That is, the dynamic label 128 is associated with the chute containing the items 108, and the dynamic label 132 is associated with the chute containing the items 112. The dynamic labels 128 and 132 contain controllable display elements, such as e-ink displays, light emitting diode (LED)-based displays, or the like. The dynamic labels 128 and 132 can therefore be controlled to present any of a wide variety of information at different times, rather than being static.

The system 100 also includes a computing device 136, connected to a network 140 such as a local area network deployed in the facility. Via the network 140, the computing device 136 can interact with other devices of the system 100 to discover which items occupy the forward positions in each chute, and may, under certain conditions, control the dynamic labels 128 and 132 to update the information presented thereon. Each dynamic label 128, 132 can therefore be updated to present information that matches the item currently in the forward position of the corresponding chute, even when that item has been misplaced (i.e. does not belong in the chute).

To that end, the system 100 also includes at least one sensor configured to detect the items 108 and 112. In the illustrated example, the system 100 includes sensors 144, 148 corresponding to each of the chutes. That is, the items 108, the sensor 144, and the dynamic label 128 are assigned to a first chute, while the items 112, the sensor 148, and the dynamic label 132 are assigned to a second chute.

The sensors 144 and 148 can be, for example, narrow-beam radio frequency identifier (RFID) readers disposed adjacent to respective chutes, such that the range of each sensor 144 and 148 encompasses substantially only the forward position of each chute. The items 108 and 112 can each carry an RFID tag containing an item identifier such as a stock-keeping unit (SKU) number, a universal product code (UPC) or the like. Thus, each sensor 144, 148 can be configured to report an item identifier to the computing device 136 for the item currently in the forward position of the corresponding chute. Based on that item identifier and on data stored at the computing device 136, the computing device 136 can then select a control action for the corresponding dynamic label 128, 132.

Certain internal components of the computing device 136 are also illustrated in FIG. 1. In particular, the computing device 136 includes a processor 150 (e.g., a central processing unit (CPU)), interconnected with a non-transitory computer readable storage medium, such as a memory 154. The memory 154 includes a combination of volatile memory (e.g., Random Access Memory or RAM) and non-volatile memory (e.g., read only memory or ROM, Electrically Erasable Programmable Read Only Memory or EEPROM, flash memory). The processor 150 and the memory 154 each comprise one or more integrated circuits.

The memory 154 stores computer readable instructions executable by the processor 150 to perform the item detection and label control functions mentioned above. In particular, the memory 154 stores a dynamic label control application 158 executable by the processor 150 to perform various actions discussed herein. The memory 154 also stores a repository 162 containing various data defining the chutes mentioned above and the associations between chutes, dynamic labels 128 and 132, items 108 and 112, and sensors 144 and 148.

The computing device 136 also includes a communications interface 166 interconnected with the processor 150. The communications interface 166 includes suitable hardware (e.g., transmitters, receivers, network interface controllers and the like) allowing the computing device 136 to communicate with other devices in the system, including the sensors 144 and 148, and the dynamic labels 128 and 132.

The system 100 may also include, in some examples, a client computing device 170 such as a tablet computer, smart phone or the like operated by a staff member of the retail facility. As will be discussed below, in some cases the computing device 136 may generate notifications for transmission to the client device 170 via the network 140, based on information gathered from the sensors 144 and 148.

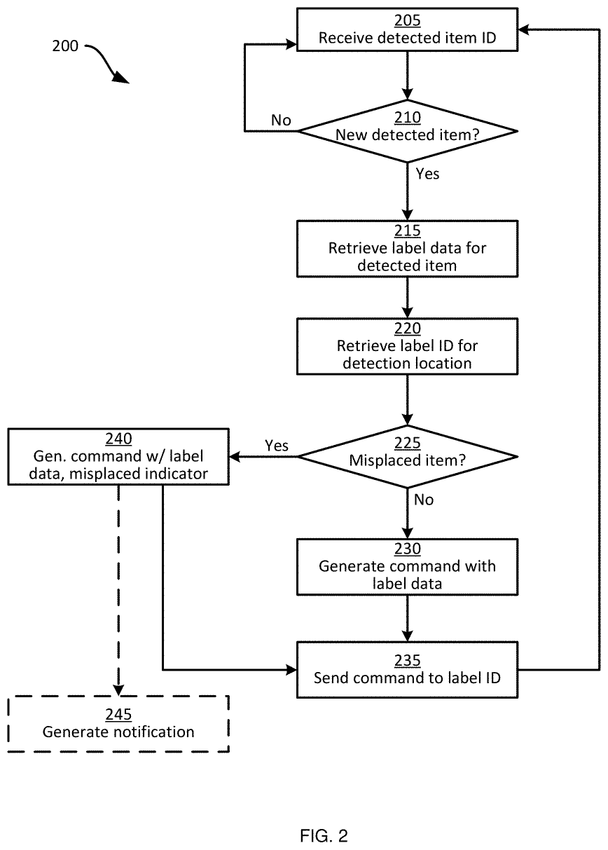

Turning to FIG. 2, a method 200 of controlling the dynamic labels 128, 132 to accurately reflect the contents of the chutes on the shelf 104 is illustrated. The method 200 will be described in conjunction with its performance within the system 100. In the discussion below, the blocks of the method 200 are performed by the computing device 136. In other examples, however, certain blocks of the method 200 can be performed by other devices, such as the client computing device 170 or the sensors 144 or 148 (e.g., depending on the computational and storage capabilities of such devices).

At block 205, the computing device 136 is configured to receive a detected item identifier from a sensor 144 or 148. The sensors 144 and 148 are each configured to poll nearby tags periodically (e.g., every second, although smaller and greater intervals may also be employed). When the sensors 144 and 148 have narrow fields of view as noted above, such periodic polling results in the detection of an item identifier affixed to the item in the forward position of the corresponding chute. Each sensor 144, 148 is configured to transmit the detected item identifier to the computing device 136 for further processing. The transmission to the computing device 136 can also include an identifier of the sensor 144 or 148 itself (e.g., a media access control (MAC) address or the like), and in some examples can also include signal strength data (e.g., a received signal strength indicator (RSSI)). The detected item identifier can therefore be associated with a particular location in the retail facility (e.g., a particular chute) according to the identity of the sensor 144, 148 from which the detected item identifier was received.

As will now be apparent, the computing device 136 can be configured to perform an instance of the method 200 for each such detection by a sensor 144, 148, and may therefore perform a number of instances of the method 200 in parallel.

Having received the detected item identifier at block 205, at block 210 the computing device 136 can be configured to determine whether the detected item identifier indicates the presence of a different item than a preceding detection. For example, the repository 162 can contain, for each chute, a preceding detected item identifier. If the item identifier received at block 205 is the same as the preceding detected item identifier, the computing device 136 may simply return to block 205, as further control of the corresponding dynamic label may not be necessary. In other examples, block 210 can be omitted.

At block 215, either following block 205 (if block 210 is omitted), or following an affirmative determination at block 210, the computing device 136 is configured to retrieve label data corresponding to the detected item identifier. Further, at block 220, the computing device 136 is configured to retrieve a dynamic label identifier corresponding to the location at which the detected item identifier was detected.

The data retrieval operations at blocks 215 and 220 are performed by retrieving data from the repository 162. The repository 162 contains a plurality of data sets, each defining a set of values associated with a given chute. Specifically, each data set includes at least an item identifier, indicating the item 108, 112 expected to be present in that chute. Each data set also includes an identifier of the dynamic label 128, 132 affixed at the relevant chute, as well as label data for that chute. The label data includes, for example, a price of the corresponding item (that is, a price for the items expected to be present in the chute). Such a price, and/or other data including an item name for example, is also referred to as reference label data.

In some examples, each data set in the repository 162 can also contain current label data, indicating what information is currently presented on the dynamic label. As will be apparent in the discussion below, the currently presented label data on a dynamic label 128, 132 can deviate from the reference label data as a result of misplaced items 108, 112. The current label data can take the form of a price or the like currently presented on the dynamic label, and/or of an item identifier that corresponds to the information currently presented on the dynamic label.

Table 1 illustrates example contents of the repository 162, reflecting the arrangement of items and chutes shown in FIG. 1.

TABLE 1
Repository 162

| Dynamic | | | Ref. Label | Current Label |
|---|---|---|---|---|
| Label ID | Item ID | Sensor ID | Data | Data/Item |
| 128 | 108 | 144 | $10.50 | 108 |
| 132 | 112 | 148 | $4.10 | 112 |

As seen in Table 1, in this example the repository includes two data sets, presented as records of a table (although the tabular format shown above is used simply for illustrative purposes, and the data therein may be stored in any suitable format). Each data set corresponds to a particular chute. Each data set further specifies which item is expected to appear in that chute, which dynamic label and sensor are deployed for that chute, as well as the reference label data for the chute. In the above example, each data set also includes an indication of either or both of the current label data, and the item currently present in the forward position of the chute.

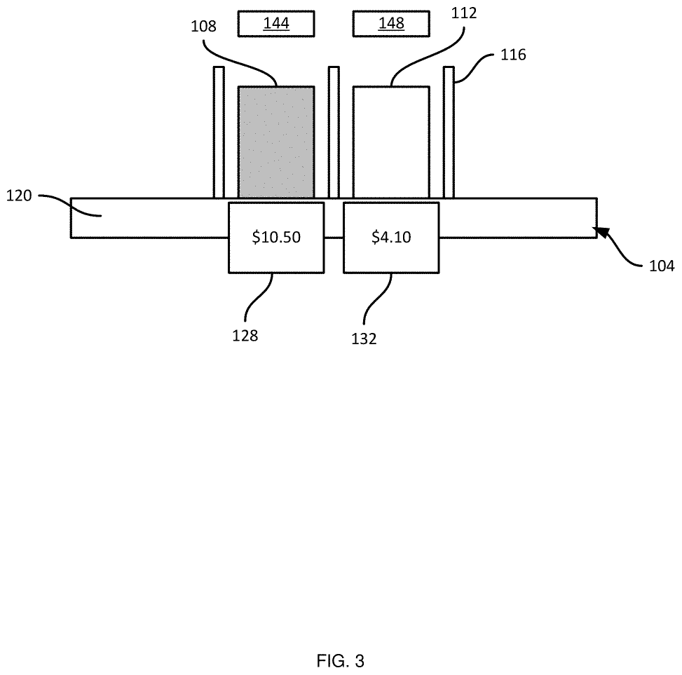

In the example above, the current data indicates that the forward item detected in the first chute is the item 108, and the forward item detected in the second chute is the item 112. The items 108 and 112, in other words, are correctly placed. FIG. 3 illustrates a front view (facing an aisle in which a customer would approach the shelf 104) of the items 108 and 112, illustrating a default configuration for the dynamic labels 128 and 132.

Referring again to FIG. 2, at block 225 the computing device 136 is configured to determine whether the item identifier received at block 205 indicates a misplaced item. The determination at block 225 can include, for example, whether the received item identifier matches the item identifier in the data set containing the sensor identifier from which the detected item identifier was received.

For example, referring to FIG. 3, when the sensor 144 reports the item identifier 108 at block 205, the computing device 136 can determine that the expected item identifier is 108 from the repository 162, because the sensor 144 is associated with the item identifier 108. The fact that the detected item identifier matches the expected item identifier results in a negative determination at block 225, because the item 108 is not misplaced. The computing device 136 therefore proceeds to block 230.

At block 230, the computing device 136 generates a command for transmission to the dynamic label whose identifier was retrieved at block 220 (that is, the dynamic label associated with the same chute as the sensor from which the detected item identifier was received at block 205). The command includes the reference label data retrieved at block 215. In this case, as shown in FIG. 3, the reference label data includes the price of the item 108 (“$10.50”). At block 235, the computing device 136 is configured to transmit the command to the relevant dynamic label, e.g., via the network 140. In response to the command, the dynamic label refreshes its display to present the reference label data contained in the command.

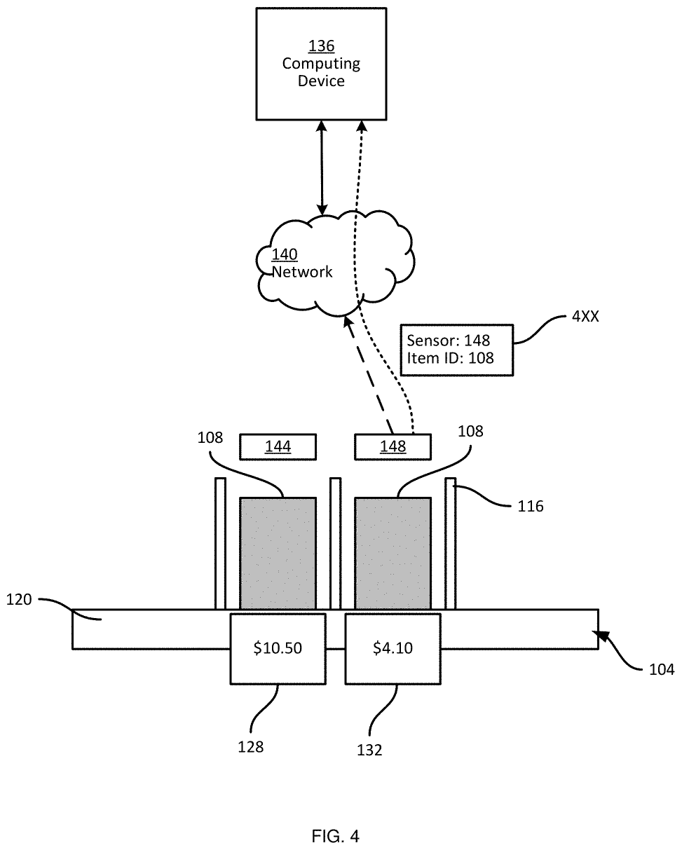

In some instances, an item may be misplaced in the facility. For example, a customer may withdraw an item 108 from the chute associated with the dynamic label 128, and later replace the item 108 in the chute associated with the dynamic label 132 (e.g., having decided that they do not wish to purchase the item 108). As a result, both of the chutes shown in FIG. 1 contain items 108 in the foremost positions. FIG. 4 illustrates a front view of this scenario, in which the forward positions of both chutes are occupied by items 108. Further, as shown in FIG. 4, immediately after placement of the item 108 in the chute intended for the items 112, the dynamic label 132 presents label information that does not match the exposed item in the corresponding chute (i.e., the price of the items 112 is shown, but no item 112 is directly accessible).

As a result of the above-mentioned polling, the sensor 148 detects a tag embedded in the item 108 in the right-hand chute, and sends a message 400 to the computing device 136, containing an identifier of the sensor 148 itself, and a detected item identifier (in this case, “108”). The message 400 is received at the computing device 136 in a further performance of block 205.

Therefore, at block 210 the computing device 136 determines that the item 108 detected in the chute corresponding to the items 112 is a new item, because (as per Table 1) the dynamic label 132 previously displayed label information for the item 112. Following an affirmative determination at block 210, at block 215 the computing device 136 retrieves the label data corresponding to the item 108 (e.g., the price $10.50). At block 220 the computing device 136 retrieves the identifier of the dynamic label 132 (i.e., the dynamic label at the same location as the sensor 148).

At block 225, the computing device 136 determines that the item 108 is a misplaced item, because the item identifier from block 250 does not match the item identifier corresponding to the sensor 148 and the dynamic label 132. Following an affirmative determination at block 225, the computing device 136 proceeds to block 240 rather than block 230.

At block 240, the computing device 136 generates a command for transmission to the dynamic label 132. In contrast to the command generated at block 230, the command generated at block 240 can include not only the reference label data for the item 108, but also a misplaced item indicator. The misplaced item indicator can include an icon, a text string indicating that this item has been misplaced, or the like. In some examples, the misplaced item indicator can be a set of parameters defining a flashing pattern, a background color or the like, to distinguish the dynamic label 132 from other dynamic labels.

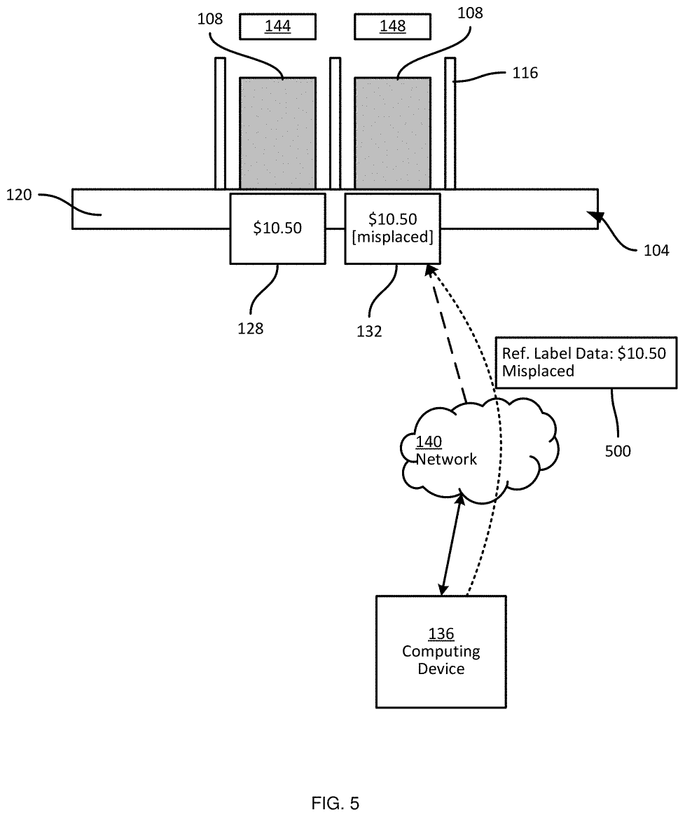

At block 235, the computing device 136 is configured to transmit the command from block 240 to the dynamic label 132 (i.e. the label whose identifier was retrieved at block 220). FIG. 5 illustrates a performance of block 235, in which a command 500 is sent from the computing device 136 to the dynamic label 132. In response to receipt of the command, the dynamic label 132 displays the price of the item 108, as well as an indication that the item 108 is misplaced. Thus, the information on the label 132 matches the accessible item in the corresponding chute, despite the item being misplaced.

The computing device 136 also, in response to sending the command, updates the repository 162, e.g., to indicate that the current label data corresponds to the item 108, rather than the item 112, as shown below in Table 2.

TABLE 2
Updated Repository 162

| Dynamic | | | Ref. Label | Current Label |
|---|---|---|---|---|
| Label ID | Item ID | Sensor ID | Data | Data/Item |
| 128 | 108 | 144 | $10.50 | 108 |
| 132 | 112 | 148 | $4.10 | 108 |

In some examples, the computing device 136 can implement additional functionality beyond that described above. For example, the computing device 136 may, at block 245 (after generating the command at block 240), generate a misplaced item notification. The notification may be transmitted to another computing device, such as the client device 170, e.g., to alert a staff member at the facility to the misplaced item. The notification may also be stored at the computing device 136, for example until a detected location of the client device 170 is within a threshold distance of a stored location of the dynamic label 132. At that point, the computing device 136 may transmit the notification to the client device 170.

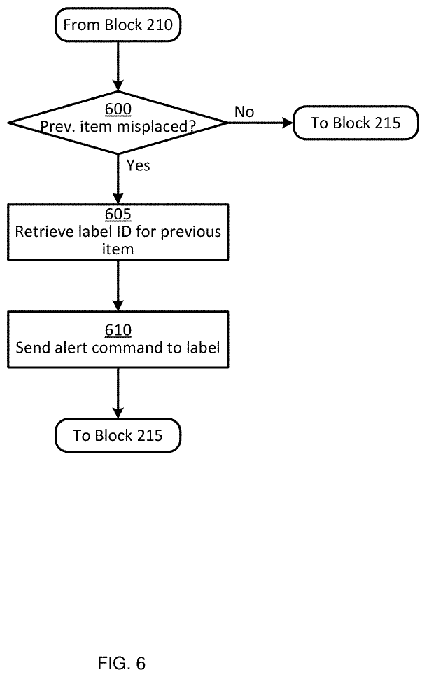

Turning to FIG. 6, in some examples additional functionality can be implemented to alert customers or staff to misplaced items in response to manipulation of those items. Specifically, FIG. 6 illustrates a set of additional actions performed following an affirmative determination at block 210 (or following block 205, when block 210 is omitted).

At block 600, the computing device 136 can be configured to determine whether the previous item was misplaced. That is, the detection of a new item via blocks 205 and 210 indicates that the previous item has been withdrawn from the chute. In some examples, the computing device 136 can also assess whether the previous item has indeed been withdrawn via monitoring of RFID tag RSSI values over time. In some examples, the sensors 144 and 148 can also include, or be augmented by, light curtains or the like to detect the presence of a hand withdrawing an item from a chute.

Determining whether the previous item was misplaced includes comparing the item identifier and the current label data for the record corresponding to the relevant sensor. If those values are equal, the previous item was not misplaced, and the determination at block 600 is negative. The computing device 136 therefore proceeds to block 215, as described above. When those values are not equal (as in the second data set in Table 2), the previous item was misplaced, and the determination at block 600 is affirmative.

Following an affirmative determination at block 600, the customer or staff member may be assumed to be holding the previously misplaced item. In order to notify the customer or staff member of the correct location for the misplaced item, at block 605 the computing device 136 retrieves an identifier of the dynamic label for the previous item. Thus, in the example shown in FIG. 5 and Table 2, if a new item is detected by the sensor 148 the determination at block 600 is affirmative, and at block 605 the computing device 136 retrieves the identifier of the label 128, as the label 128 corresponds to the previous item 108 (which was misplaced in the chute corresponding to the item 112).

At block 610, the computing device 136 sends an alert command to the dynamic label identified at block 605. Thus, in the example mentioned above, when a new item (e.g., an item 112) is detected in the chute corresponding to the sensor 148, the item 108 that was misplaced in that chute is assumed or detected to have been withdrawn. The computing device 136 thus sends an alert command to the dynamic label 128, which is the correct location for the (now withdrawn) misplaced item. The alert command can instruct the dynamic label 128 to flash, change a background color thereof, or the like, to signal to the customer or staff member the correct location of the item that they are assumed to currently be holding.

Further variations to the above are contemplated. For example, various sensing technologies other than RFID as mentioned above may be employed, including optical sensors such as cameras or the like, smart mats, depth sensors (e.g. stereo cameras, lidar sensors, or the like). In further examples, updates to the dynamic labels 128 and 132 via block 235 may be delayed for a predefined time period (e.g., five seconds) after the first detection of a new item at block 205.

As will be apparent to those skilled in the art, the system 100 enables the display of label information, such as pricing for an item, that accurately reflects the item most readily accessible to a user, whether that item is misplaced or not. The system 100 may therefore reduce or avoid instances of customers discovering at checkout that an item costs more than expected.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A method for accurate cost reporting of shelved items, comprising:
storing a plurality of data sets corresponding to respective chutes in a facility, each data set containing (i) an item identifier, (ii) label data, and (iii) an identifier of a dynamic label disposed at a corresponding chute;
receiving, from a sensor mounted at or near a first one of the chutes, a detected item identifier corresponding to a forward position in the chute that is adjacent to an edge of a shelf defining the chute;
retrieving, from the repository, (i) the identifier of a first dynamic label corresponding to the first chute, and (ii) detected label data from one of the data sets containing the detected item identifier; and
sending a command to the first dynamic label, the command containing the detected label data, for causing the first dynamic label to display the detected label data.

2. The method of claim 1, wherein the identifier of the first dynamic label and the label data are retrieved from different ones of the data sets.

3. The method of claim 1, wherein the label data includes (i) reference label data corresponding to the item identifier, and (ii) currently displayed label data.

4. The method of claim 3, further comprising:
retrieving the currently displayed label data from the data set containing the first dynamic label identifier;
prior to sending the command, determining that the retrieved currently displayed label data is different from the reference label data from the one of the data sets containing the detected item identifier.

5. The method of claim 1, wherein each data set includes an identifier of the sensor mounted at the corresponding chute; and
wherein retrieving the identifier of the first dynamic label includes retrieving the first dynamic label identifier from one of the data sets containing the identifier of the sensor mounted at the first chute.

6. The method of claim 1, further comprising:
determining that the detected item identifier is different from the item identifier in the data set containing the first dynamic label identifier; and
prior to sending the command, generating the command including the detected label data and a misplaced item indicator.

7. The method of claim 6, wherein the misplaced item indicator includes label data from the data set containing the first dynamic label identifier.

8. The method of claim 1, further comprising:
prior to the retrieving, determining that the detected item identifier is different from a preceding detected item identifier corresponding to the first chute.

9. A computing device, comprising:
a memory storing a plurality of data sets corresponding to respective chutes in a facility, each data set containing (i) an item identifier, (ii) label data, and (iii) an identifier of a dynamic label disposed at a corresponding chute;
a communications interface; and
a processor configured to:
receive, from a sensor mounted at a first one of the chutes, a detected item identifier corresponding to a forward position in the chute that is adjacent to an edge of a shelf defining the chute;
retrieve, from the repository, (i) the identifier of a first dynamic label corresponding to the first chute, and (ii) detected label data from one of the data sets containing the detected item identifier; and
send a command to the first dynamic label, the command containing the detected label data, for causing the first dynamic label to display the detected label data.

10. The computing device of claim 9, wherein the identifier of the first dynamic label and the label data are retrieved from different ones of the data sets.

11. The computing device of claim 9, wherein the label data includes (i) reference label data corresponding to the item identifier, and (ii) currently displayed label data.

12. The computing device of claim 11, wherein the processor is further configured to:
retrieve the currently displayed label data from the data set containing the first dynamic label identifier;
prior to sending the command, determine that the retrieved currently displayed label data is different from the reference label data from the one of the data sets containing the detected item identifier.

13. The computing device of claim 9, wherein each data set includes an identifier of the sensor mounted at the corresponding chute; and
wherein the processor is configured to retrieve the identifier of the first dynamic label by retrieving the first dynamic label identifier from one of the data sets containing the identifier of the sensor mounted at the first chute.

14. The computing device of claim 9, wherein the processor is further configured to:
determine that the detected item identifier is different from the item identifier in the data set containing the first dynamic label identifier; and
prior to sending the command, generate the command including the detected label data and a misplaced item indicator.

15. The computing device of claim 13, wherein the misplaced item indicator includes label data from the data set containing the first dynamic label identifier.

16. The computing device of claim 9, wherein the processor is further configured to:
prior to the retrieving, determine that the detected item identifier is different from a preceding detected item identifier corresponding to the first chute.

17. A system, comprising:
a plurality of sensors disposed at respective chutes in a facility;
a plurality of dynamic labels disposed at respective ones of the chutes; and
a computing device including:
a memory storing a plurality of data sets corresponding to respective ones of the chutes in a facility, each data set containing (i) an item identifier, (ii) label data, and (iii) an identifier of the dynamic label disposed at a corresponding chute;
a communications interface; and
a processor configured to:
receive, from one of the sensors at a first one of the chutes, a detected item identifier corresponding to a forward position in the chute that is adjacent to an edge of a shelf defining the chute;
retrieve, from the repository, (i) the identifier of a first one of the dynamic labels corresponding to the first chute, and (ii) detected label data from one of the data sets containing the detected item identifier; and
send a command to the first dynamic label, the command containing the detected label data, for causing the first dynamic label to display the detected label data.

18. The system of claim 17, wherein the system includes a radio frequency identification (RFID) sensor.

19. The system of claim 17, wherein the dynamic label includes a display panel.

20. The system of claim 18, wherein the display panel includes an e-ink panel.
